(19) United States
(12) Patent Application Publication
(10) Pub. No.: US 2026/0081627 A1
(43) Pub. Date: Mar. 19, 2026

(54) MITIGATION OF TRANSMITTED ENERGY ON SUBCARRIERS USING DYNAMIC AMPLIFICATION

(71) Applicant: T-MOBILE INNOVATIONS LLC, Overland Park, KS (US)

(72) Inventors: Sharath SOMASHEKAR, Leawood, KS (US); Deveshkumar Narendrapratap RAI, Overland Park, KS (US)

(21) Appl. No.: 18/885,044

(22) Filed: Sep. 13, 2024

(51) Int. Cl. H04B 1/00; H04L 5/00

(52) U.S. Cl. CPC H04B 1/0078; H04B 1/0071; H04L 5/0098

(57) ABSTRACT

Embodiments of the present disclosure are directed to systems and methods for mitigating energy transmitted on subcarriers in a communications network. For example, an operational bandwidth of an amplifier may be adjusted in real-time based on the network’s current needs. A controller may communicate with a scheduler to identify which range of frequencies within an input signal received at the amplifier contain blanked PRBs and which contain active PRBs. The amplifier may then selectively amplify only the active PRB frequencies and exclude the blanked PRBs, thereby reducing residual energy transmission and interference typically caused when blanked PRBs are amplified.

### SUMMARY

The present disclosure is directed, in part, to mitigating energy transmitted on subcarriers in a communications network by using a dynamic amplifier, substantially as shown and/or described in connection with at least one of the figures, and as set forth more completely in the claims.

According to various aspects of the technology, communication networks typically provide a range of services, including voice, text, and data transmissions to facilitate communication among users through, for example, base stations and/or user equipment. In modern communications networks, Physical Resource Block (PRB) blanking is used to help mitigate interference and improve network performance. However, despite the implementation of PRB blanking, residual energy transmission within the blanked PRBs continues to pose challenges for operators. This issue arises due to various factors, including spectral leakage, sidelobes from modulation techniques, and the imperfect performance (e.g., nonlinearity) of power amplifiers (PAs). These unwanted energy transmissions within the blanked PRBs can have detrimental effects on the communications network. They lead to increased interference, reducing the quality of service for users and potentially causing errors in data transmission. Furthermore, this interference can extend beyond the intended network, affecting other nearby communication networks operating in adjacent frequency bands. As a result, the efficiency and reliability of the entire communication ecosystem can become compromised.

To address the problem of residual energy transmission in blanked PRBs, an operational bandwidth of an amplifier can be dynamically adjusted. For example, the amplifier can selectively amplify only the frequencies corresponding to non-blanked PRBs while not amplifying the frequencies associated with blanked PRBs. The process may begin with a scheduler and/or a transceiver module (e.g., a Digital Signal Processor (DSP)) determining the allocation of PRBs in a signal intended for transmission, which may include identifying which PRBs will be blanked and which will be active. This information (e.g., scheduling data) may be communicated to the amplifier’s control system (e.g., a controller). The amplifier’s control system may then dynamically adjust the amplifier’s operational bandwidth based on this information. For example, the operational bandwidth of the amplifier may be narrowed to exclude the frequencies of the blanked PRBs, thus preventing their amplification. Simultaneously, the control system may ensure that the frequencies of the non-blanked PRBs are within the operational range and are appropriately amplified. By dynamically modifying the amplifier’s operational bandwidth in real-time, the residual energy transmission on blanked PRBs can be mitigated, which may be helpful for minimizing interference and enhancing the quality of service. Additionally, the impact on nearby networks operating in adjacent frequency bands may also be reduced.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of an exemplary method for mitigating energy transmission in which implementations of the present disclosure may be employed;

FIG. 4 illustrates a flow chart of an exemplary method for mitigating energy transmission in which implementations of the present disclosure may be employed;

FIG. 5 illustrates a flow chart of an exemplary method for mitigating energy transmission in which implementations of the present disclosure may be employed; and

FIG. 6 illustrates a flow chart of an exemplary method for mitigating energy transmission in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

The example aspects and embodiments described in the present disclosure are provided within the context of a wireless telecommunication network for illustrative purposes. However, it should be understood that the principles and techniques discussed herein are not limited to wireless networks alone. The concepts and methodologies can be equally applied to other types of communication networks, including but not limited to wired, satellite, and optical networks. These alternative networks are capable of supporting the functionalities and applications described, and their use falls within the scope of the present disclosure.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

As used herein, the term “base station” or “cell” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

“User equipment” (UE), “user device,” “mobile device,” and “wireless communication device” are used interchangeably to refer to a device having hardware and software that is employed by a user in order to send and/or receive electronic signals/communication over one or more networks. User devices generally include one or more antennas coupled to a radio for exchanging (e.g., transmitting and receiving) transmissions with an in-range base station that also has an antenna or antenna array. In aspects, user devices may constitute any variety of devices, such as a personal computer, a laptop computer, a tablet, a netbook, a mobile phone, a smartphone, a personal digital assistant, a wearable device, a fitness tracker, or any other device capable of communicating using one or more resources of the network. User devices may include components such as software and hardware, a processor, a memory, a display component, a power supply or power source, a speaker, a touch-input component, a keyboard, and the like. In various examples or scenarios that may be discussed herein, user devices may be capable of using 5G technologies with or without backward compatibility to prior access technologies, although the term is not limited so as to exclude legacy devices that are unable to utilize 5G technologies, for example.

The term “radio unit” (RU) is used herein to refer to one or more software and hardware components that facilitate sending and receiving wireless radio frequency signals, for example, based on instructions from a base station. A RU may be used to initiate and generate information that is then sent out through the antenna array, for example, where the radio and antenna array may be connected by one or more physical paths. A RU may comprise such things as a transceiver module (e.g., including a Digital-to-Analog Converter), an amplifier, an antenna array, and/or a controller. Generally, an antenna array comprises a plurality of individual antenna elements. The antennas discussed herein may be dipole antennas having a length, for example, of ¼, ½, 1, or 1½ wavelengths. The antennas may be monopole, loop, parabolic, traveling-wave, aperture, yagi-uda, conical spiral, helical, conical, radomes, horn, and/or apertures, or any combination thereof. The antennas may be capable of sending and receiving transmission via FD-MIMO, Massive MIMO, 3G, 4G, 5G, and/or 802.11 protocols and techniques.

The term “baseband unit” (BBU) is used herein to refer to one or more software and hardware components that facilitates processing digital signals before transmission (e.g., a baseband signal). A BBU may be used to handle various protocol layers, including Medium Access Control (MAC), Radio Link Control (RLC), and Packet Data Convergence Protocol (PDCP), which help ensure proper data formatting, sequencing, and error handling. A BBU may also manage the flow of data between the network core and the RU, ensuring that user data, control signals, and other necessary information are efficiently processed and transmitted. A BBU may comprise such things as a scheduler, a Digital Signal Processor (DSP), and/or a controller.

“Physical resource block” (PRB) is used to refer to a defined quantity of consecutive subcarriers in a frequency domain that is used for wireless transmission and wireless reception of waveform signals via antennas/antenna elements. In some instances, a physical resource block has a defined quantity of consecutive subcarriers in a frequency domain within one slot in a time domain (e.g., LTE). In other instances, a physical resource block has a defined quantity of consecutive subcarriers in a frequency domain independent of the time domain (e.g., 5G NR). In one example, one resource block has twelve consecutive subcarriers of a frequency domain, where one subcarrier corresponds to one resource element in the resource block. The bandwidth of various physical resource blocks is dependent on the numerology and subcarrier spacing utilized, which corresponds to the frequency bands as defined in kilohertz (kHz) and which determines the cyclic prefix of said block in milliseconds (ms). For example, 5G NR technology supports subcarrier spacing of 15, 30, 60, 120, and 240 kHz while LTE technology supports only one subcarrier spacing of 15 kHz. The physical resource blocks form bandwidth parts (BWP). The physical resource blocks discussed herein are compatible and usable in LTE, LTE-M, 3G, 4G, 5G, IoT, IIoT, NB-IoT, and similar technologies without limitation. For this reason, physical resource blocks are discussed herein in a network-agnostic manner, as the aspects discussed herein can be implemented within each of the different technology environments.

By way of background, PRB blanking is an interference management technique employed in modern communication networks and may be employed at base stations and/or user equipment. In these networks, data transmission may be organized into resource blocks, each of which spans a specific number of subcarriers in the frequency domain and a certain number of symbols in the time domain. Efficient and effective management of these resource blocks is helpful for optimizing network performance and ensuring reliable communication. One of the purposes of PRB blanking is to reduce inter-cell and intra-cell interference, particularly in scenarios with both macro cell and small cells. In such environments, high-power macro cell transmissions can cause significant interference to nearby low-power small cells or user equipment. By strategically blanking certain PRBs, the network can lower interference in both the time and frequency intervals, allowing small cells and other low-power nodes to operate more effectively.

Despite the strategic implementation of PRB blanking to manage interference in communications networks, residual energy transmission within the blanked PRBs remains a persistent issue in real-world scenarios. This problem arises from several technical factors that complicate the ideal functioning of PRB blanking. In practice, the finite response of filters and the inherent sidelobes generated by some modulation techniques lead to spectral leakage, where some energy spills into adjacent frequencies, including those designated as blanked PRBs. Moreover, power amplifiers (PAs), which are important for boosting the signal strength for transmission, often exhibit nonlinear behavior. This nonlinearity results in the generation of harmonics and intermodulation products that further contaminate the blanked PRBs with unwanted energy. Additionally, since amplifiers do not completely turn off, residual energy may still be transmitted on blanked PRBs even when the blanked PRBs carry no information. These imperfections in the amplification and modulation processes cause energy to be transmitted within the blanked PRBs, undermining the intended interference mitigation. For example, the interference levels may degrade the quality of service for users and lead to higher error rates and reduced data throughput. Furthermore, this interference may not be confined to the intended network alone but may also affect nearby communications networks operating in adjacent frequency bands, causing broader spectrum management issues. As a result, the efficiency and reliability of both the local network and the surrounding communication infrastructure may become compromised, highlighting the need for more effective solutions to address this issue.

Conventionally, amplifiers in communications networks are designed to amplify signals across a fixed, static operational bandwidth, regardless of the specific context of the signals within that range. Because conventional amplifiers amplify all signals within their fixed operational bandwidth, they end up amplifying residual energy within blanked PRBs. This residual energy can cause interference, reducing the overall quality of service. For example, the lack of dynamic adjustment means that the amplifier cannot optimize its performance based on the specific needs of the network at any given time.

To address the issue of residual energy transmission in blanked PRBs, the present disclosure is directed to systems and methods for mitigating energy transmitted on subcarriers in a communications network by using a dynamic amplifier during the amplification process. For example, an operational bandwidth of an amplifier may be dynamically adjusted to help ensure that only the frequencies corresponding to non-blanked PRBs are amplified, while frequencies corresponding to blanked PRBs are not. This method may be facilitated by an intelligent controller that communicates with a scheduler in the communications network. The method may begin with the scheduler allocating PRBs for an upcoming transmission cycle by designating certain PRBs as blanked (e.g., a first range of frequencies) and others as active for data transmission (e.g., non-blanked PRBs). This scheduling data, detailing which frequency ranges are associated with the blanked and non-blanked PRBs, is communicated to the controller. When a signal (e.g., an input signal) comprising a range of frequencies with blanked PRBs and a range of frequencies with non-blanked PRBs is received at the amplifier, the controller may analyze the input signal and/or the scheduling data to identify the exact frequency bands that correspond to the blanked and non-blanked PRBs. Using this information, the controller may dynamically adjust the amplifier’s operational bandwidth. For example, the operational bandwidth may be narrowed to exclude the frequencies associated with the blanked PRBs, thereby preventing amplification of these frequencies. Simultaneously, the controller may help ensure that the operational bandwidth includes the frequencies of the non-blanked PRBs, allowing them to be amplified appropriately. This dynamic adjustment may be performed in real-time, allowing the communications network to respond instantly to any changes in the PRB allocation. By dynamically managing the amplifier’s operational bandwidth, quality of service may be enhanced for users and adverse effects may be mitigated for both the communications network and nearby networks operating in adjacent frequency bands.

Accordingly, a first aspect of the present disclosure is directed to a system for mitigating energy transmitted on subcarriers in a communications network. The system includes a radio unit comprising an amplifier and a network device comprising one or more processors. The system further includes a non-transitory computer-readable media configured to receive an input signal at the amplifier, the input signal comprising a first range of frequencies and a second range of frequencies. The media is further configured to determine that the first range of frequencies comprises blanked PRBs and to dynamically adjust an operational bandwidth of the amplifier such that, when the input signal is amplified by the amplifier, the first range of frequencies is not amplified. The media is further configured to amplify the second range of frequencies using the dynamically adjusted operational bandwidth of the amplifier.

A second aspect of the present disclosure is directed to a non-transitory computer-readable media that, when executed, cause a user equipment comprising one or more processors to perform operations for mitigating energy transmitted on subcarriers in a communications network. For example, the computer-readable media is configured to receive an input signal at an amplifier, the input signal comprising a first range of frequencies and a second range of frequencies. The media is further configured to dynamically adjust an operational bandwidth of the amplifier such that, when the input signal is amplified by the amplifier, the first range of frequencies is not amplified. The media is further configured to amplify the second range of frequencies using the dynamically adjusted operational bandwidth of the amplifier.

A third aspect of the present disclosure is directed to a method for mitigating energy transmitted on subcarriers in a communications. The method includes determining that an input signal comprises a first range of frequencies and a second range of frequencies. The method further includes dynamically adjusting an operational bandwidth of an amplifier such that, when the input signal is amplified by the amplifier, the first range of frequencies is not amplified. The method further includes amplifying the second range of frequencies using the dynamically adjusted operational bandwidth.

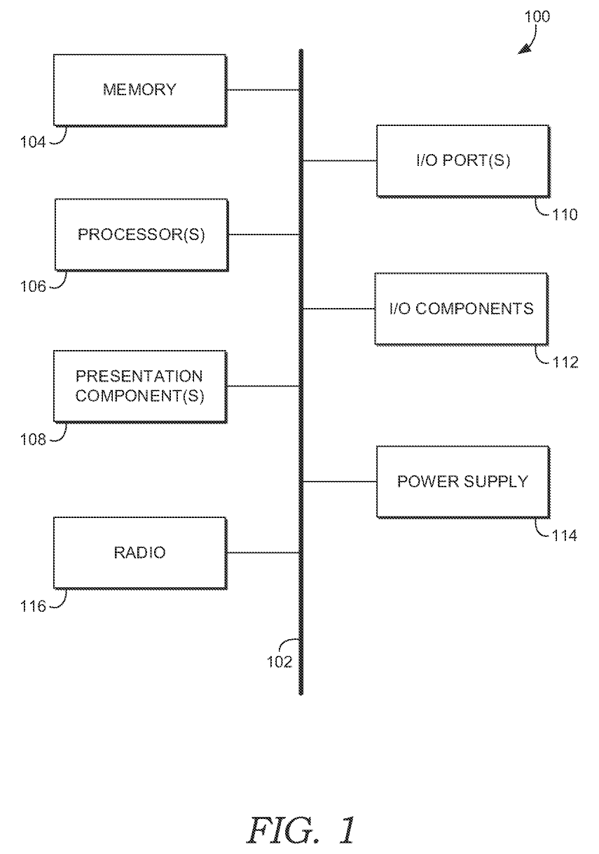

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitter to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

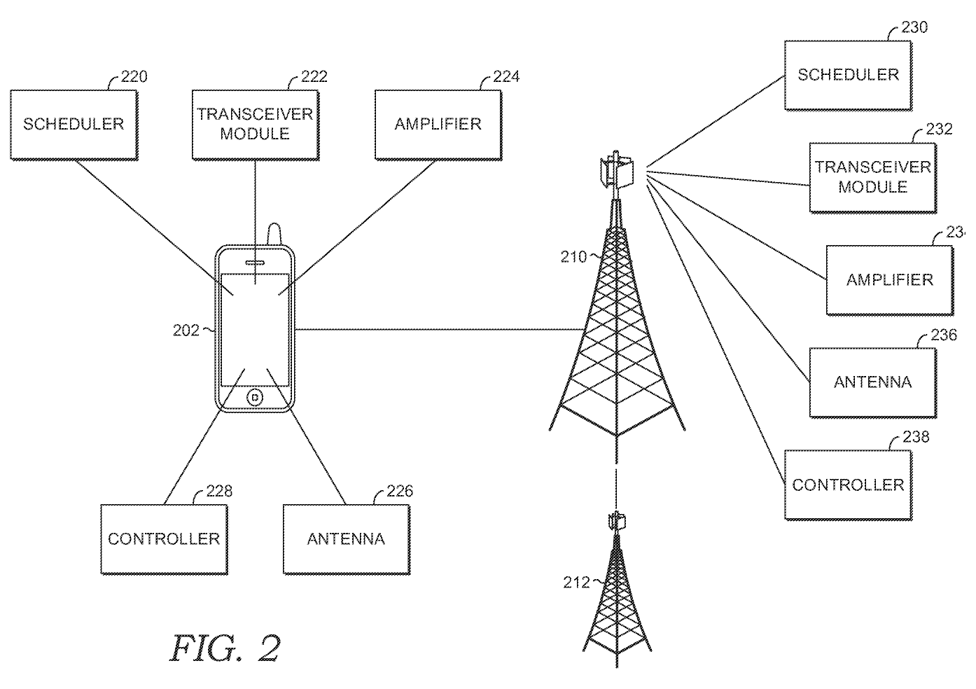

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as UE 202, one or more base stations, such as a first base station 210 and/or a second base station 212, and additional components of radio units at the first UE 202 and the first base station 210, though in some implementations, it may not be necessary for certain features to be present. For example, in some aspects, the network environment 200 may not comprise the second base station 212 (e.g., when the first UE 202 is transmitting toward the first base station 210) and/or may not comprise the first UE 204 (e.g., when the first base station 210 is transmitting toward the second base station 212). The network environment may include a number of routers, switches, and the like. The network environment 200 is generally configured for wirelessly connecting the first UE 202 to data or services that may be accessible on one or more application servers or other functions, nodes, or servers not pictured in FIG. 2 so as to not obscure the focus on the present disclosure.

The network environment 200 comprises the first UE 202, which is illustrated generally, and may take any number of forms, including a tablet, phone, or wearable device, or any other device discussed with respect to FIG. 1 and may have any one or more components or features of the computing device 100 of FIG. 1. In some aspects, the first UE 202 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The network environment 200 comprises one or more of the first base station 210 and/or the second base station 212 to which the first UE 202 may potentially connect to (also referred to as ‘camping on,’ ‘attaching,’ in the industry). Though network environment 200 is illustrated with both the first base station 210 and the second base station 212, one skilled in the art will appreciate that more or fewer base stations may be present in any particular network environment. Furthermore, the first base station and the second base station 212 may have any one or more components or features of the computing device 100 of FIG. 1. Each of the first base station 210 and the second base station 212 of the network environment 200 is configured to wirelessly communicate with UEs, such as the first UE 202 and/or other base stations (e.g., such as each other). In aspects, any of first base station 210 and the second base station 212 may communicate with one or more of the first UE 202 or each other using any wireless telecommunication protocol desired by a network operator, including but not limited to 3G, 4G, 5G, 6G, 802.11x and the like. However, in some aspects, signals from the first UE 202, the first base station 210, and/or the second base station 212 may be transmitted towards one another without being in direct communication with one another. For example, energy transmitted on blanked PRBs in the signals can cause interference between base stations and user equipment within a communications network as well as external networks by the energy transmissions in certain bands of the transmitted signals.

The network environment 200 comprises components of the radio units on the first UE 202 and the first base station 210. The illustrated components for a radio unit of the first UE 202 may include a transceiver module 222, an amplifier 224, an antenna array 226, and/or a controller 228, which may communicate with, and/or be coordinated by, a scheduler 220. Similarly, the illustrated components for the radio unit on the first base station 210 may include a transceiver module 232, an amplifier 234, an antenna array 236, and/or a controller 230, which may communicate with, and be coordinated by, a scheduler 230. Additional components of the radio units may be present but are not illustrated and/or discussed for the sake of clarity. For example, it may be understood that the second base station 212 has similar components, although not illustrated.

The schedulers 220,230 help by efficiently allocating resources to ensure optimal performance and adherence to system constraints. Specifically, when dealing with blanked PRBs, the schedulers 220,230 must strategically manage the distribution of available PRBs to various users and services. Blanked PRBs are intentionally left unused to avoid interference and/or to meet certain regulatory requirements. By dynamically adapting to real-time conditions and considering the presence of blanked PRBs, the schedulers 220,230 help to optimize the use of available resources, maintain signal quality, and enhance the overall efficiency of the system. The schedulers 220,230 interact with the other components in the radio units. For example, in the context of the first UE 202, the scheduler 220 may interact with the transceiver module 222, the amplifier 224, and the antenna array 226 by determining the optimal allocation of resources and transmission parameters, then instructing these components to implement the planned signal transmissions. The scheduler 220 may help ensure that the transceiver module 222 processes and modulates the signal appropriately, that the amplifier 224 provides the necessary power levels, and that the antenna array 226 directs the signal accurately towards its intended recipient. The scheduler 220 may prepare a data packet (e.g., comprising digital signal data) containing scheduling information (e.g., scheduling data) to send to the controller 228. For example, the scheduling information (e.g., associated with the input signal) may include a list of active PRBs designated for data transmission (e.g., non-blanked PRBs), a list of blanked PRBs where non data will be transmitted, and/or timing information to ensure synchronization with other network components. By sending this scheduling information, the scheduler 220 helps ensure that the controller 228 is informed about which PRBs are active and which are blanked, allowing the scheduler to make better real-time adjustments to the amplifier’s bandwidth and optimize network performance. Scheduler 230 may provide similar functionality for the first base station 210.

The transceiver modules 222,232 may serve as the central component responsible for converting digital data into radio frequency signals and vice versa. For example, in the context of preparing a signal for transmission that includes blanked PRBs, the transceiver modules 222,232 may receive scheduling instructions that specify which PRBs are blanked and which are available for transmission. The transceiver modules 222,232 process the information to modulate the signal appropriately, ensuring that no data is transmitted over the blanked PRBs to help avoid interference and meet regulatory constraints; however, as discussed previously, there still remains the problem of residual energy transmission even though no data is being transmitted. The transceiver modules 222,232 may work with a Digital Signal Processor (DSP) to encode and modulate the signal and with the schedulers 220,230 to ensure compliance with the resource allocation plan. For example, the transceiver modules 222,232 may convert a baseband signal to an analog signal. Once the signal is prepared, the transceiver modules 222,232 send the signal to the amplifiers 224,234.

The amplifiers 224,234 may refer to a device that increases the power of a signal to ensure it can be transmitted over longer distances without degradation. The amplifiers 224,234, as discussed herein, may encompass both driver amplifiers and power amplifiers. Driver amplifiers are typically used to provide the necessary gain to drive the input of a subsequent stage, such as a power amplifier. Driver amplifiers operate at lower power levels and serve to prepare the signal for final amplification. Power amplifiers, on the other hand, operate at higher power levels and are responsible for providing the final boost to the signal. When referring to the amplifiers 224,234, it could mean one or more amplifiers (e.g., a plurality of amplifiers) and include any combination of driver amplifiers, power amplifiers, or multiple units of either type.

In order to address the issue of unwanted residual energy transmission on blanked PRBs, conventional amplifiers may need to be replaced or upgraded to support dynamic control capabilities. As discussed previously, conventional amplifiers may operate over a fixed, static bandwidth, and they may uniformly amplify all frequencies within this range without discrimination. For example, they may provide a constant gain across the entire operational bandwidth, amplifying both desired signals and any residual energy or interference present in the blanked PRBs. By uniformly amplifying the entire bandwidth, conventional amplifiers may inadvertently boost residual energy in blanked PRBs, leading to increased interference. By replacing or upgrading to dynamic amplifiers, such as the amplifiers 224,234, which may be equipped with intelligent control systems (e.g., controllers 228,238) that allow them to adjust their operational bandwidth in real-time, they can selectively amplify frequencies associated with active PRBs while excluding those of blanked PRBs. The dynamic amplifiers may be integrated with the existing network schedulers and/or controllers to help coordinate real-time communication and adjustments.

The term “operational bandwidth” of an amplifier as used herein may refer to a specific range of frequencies over which the amplifier can effectively amplify signals. For example, it may define the frequency limits within which the amplifier operates and provides gain.

The antenna arrays 226,236 help with shaping and directing the signal for transmission. The antenna arrays 226236 take the input signal, which is now an aggregate of all the active frequency bands, and applies beamforming techniques to focus the transmission towards the intended target. The ultimate signal transmitted by the antenna arrays 226,236 is a radio frequency signal where the blanked PRBs were not amplified. This signal helps ensure reliable communication with minimal interference.

The controllers 228,238 may be a newly added component or may be integrated into an existing component such as the amplifiers 224,234. The controllers 228,238 described herein may be implemented as hardware, software, or a combination of both. The specific implementation may vary depending on system requirements and design considerations. The controllers 228,238 may be responsible for coordinating and executing the adjustment of the operational bandwidth of the amplifiers 224,234 for each transmission cycle. For example, the controllers 228,238 may interface seamlessly with the schedulers 220,230 to manage and optimize the operational bandwidth of the amplifiers 224,234.

The controllers 228,238 may dynamically adjust the operational bandwidth of the amplifiers 224,234. For example, based on the scheduling data received from the schedulers 220,230, the controllers 228,238 may determine the allocation of PRBs within the input signal received at the amplifiers 224,234. The determination may include identifying which frequency ranges within the input signal comprise blanked PRBs and which comprise non-blanked PRBs.

In some aspects, the controllers 228,238 may determine that a first range of frequencies within the input signal comprises only blanked PRBs based on the provided scheduling data. In order to minimize interference, the controllers 228,238 may dynamically adjust the operational bandwidth of the amplifiers 224,234 to not amplify the first range of frequencies. For example the adjustment may comprise narrowing the bandwidth to exclude the first range of frequencies. In such an aspect, the controllers 228,238 may also identify a second range of frequencies within the input signal comprises non-blanked PRBs based on the provided scheduling data. The controllers 228,238 may configure the amplifiers 224,234 to include the second range of frequencies within its operational bandwidth so that the second range of frequencies will be amplified to the appropriate level (e.g., broadening the operational bandwidth to include the second range of frequencies). In such aspects the controllers 228,238 may also identify a third range of frequencies comprising blanked PRBs. When the second range of frequencies, which contains non-blanked PRBs, lies between the first range of frequencies and the third range of frequencies, the controllers 228,238 may ensure that the amplifiers’ 224,234 operational bandwidth is adjusted such that only the second range of frequencies is amplified, effectively excluding both the first range of frequencies and the third range of frequencies from amplification.

Conversely, in other aspects where the scenario is reversed and the first range of frequencies and the third range of frequencies comprise non-blanked PRBs while the second range of frequencies comprises blanked PRBs, the controllers 228,238 may dynamically adjust the amplifier’s operational bandwidth to exclude the second range of frequencies. For example, the controllers 228,238 may narrow the operational bandwidth of the amplifiers 224,234 to narrow the bandwidth so that only the first range of frequencies and the third range of frequencies is amplified.

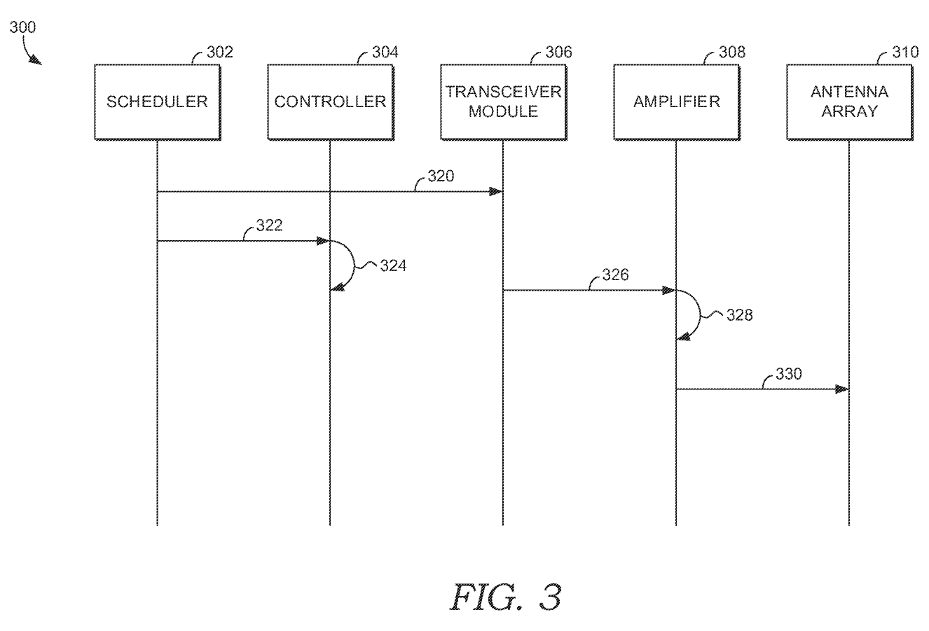

FIG. 3 illustrates an example flow diagram for mitigating energy transmitted on subcarriers in a communications network in accordance with aspects herein. The components discussed may be the same or similar to previous components discussed with regards to FIGS. 1-2. At a first step 320, a scheduler 302 and/or a DSP processes a baseband signal, which may include preparing the signal with the appropriate modulation and encoding, and then sending it to a transceiver module 306. At a second step 322, the scheduler 302 may prepare and send scheduling data for the signal to a controller 304. The scheduling data may include information about which PRBs are active (e.g., non-blanked) and which are blanked, along with the associated frequency ranges of these PRBs.

At a third step 324, the controller 304 may analyze the scheduling data to determine which ranges of frequencies correspond to blanked PRBs and which correspond to non-blanked PRBs. At a fourth step 326, the transceiver module 306 may process the signal as per standard procedures, which may include converting the baseband signal to an analog signal, and then send the processed signal to the amplifier 308 as an input signal for the amplifier 308.

At a fifth step 328, the controller 304 may dynamically adjust the operational bandwidth of the amplifier 308 such that, when the input signal is amplified by the amplifier 308, only the frequency ranges containing non-blanked PRBs are amplified. Frequency ranges corresponding to blanked PRBs may be excluded from amplification. At a sixth step 330, the amplified signal, having only amplified the non-blanked PRBs, is passed to an antenna array 310. The antenna array 310 may use beamforming to direct and shape the signal for transmission to an intended target.

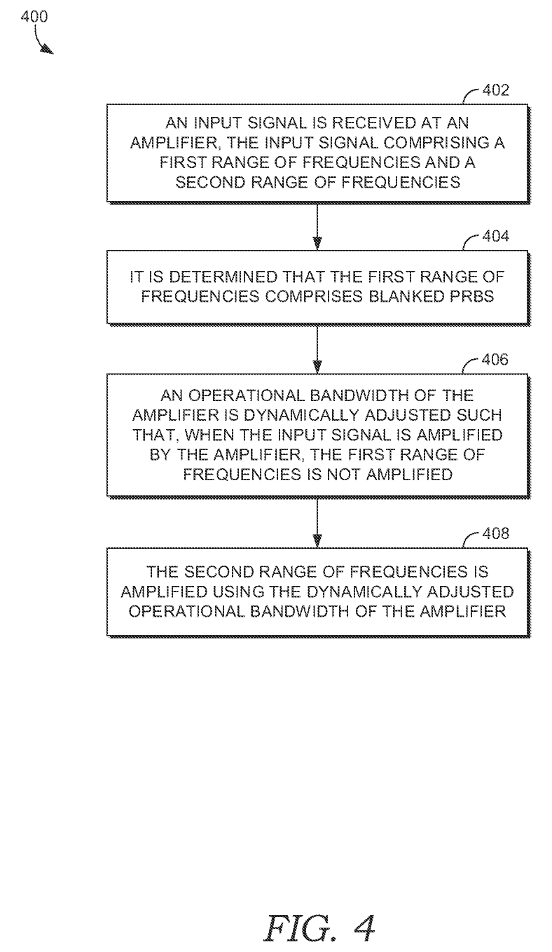

Turning now to FIG. 4, a flow chart is provided that illustrates one or more aspects of the present disclosure relating to a method 400 for mitigating energy transmitted on subcarriers in a communications network. At a first step 402, an input signal is received at an amplifier, the input signal comprising a first range of frequencies and a second range of frequencies. In some aspects, the input signal is received from a transceiver module of a base station. In other aspects, the input signal is received from a transceiver module of a user equipment. At a second step 404, it is determined that the first range of frequencies comprises blanked PRBs. At a third step 406, an operational bandwidth of the amplifier is dynamically adjusted such that, when the input signal is amplified by the amplifier, the first range of frequencies is not amplified. At a fourth step 408, the second range of frequencies is amplified using the dynamically adjusted operational bandwidth of the amplifier.

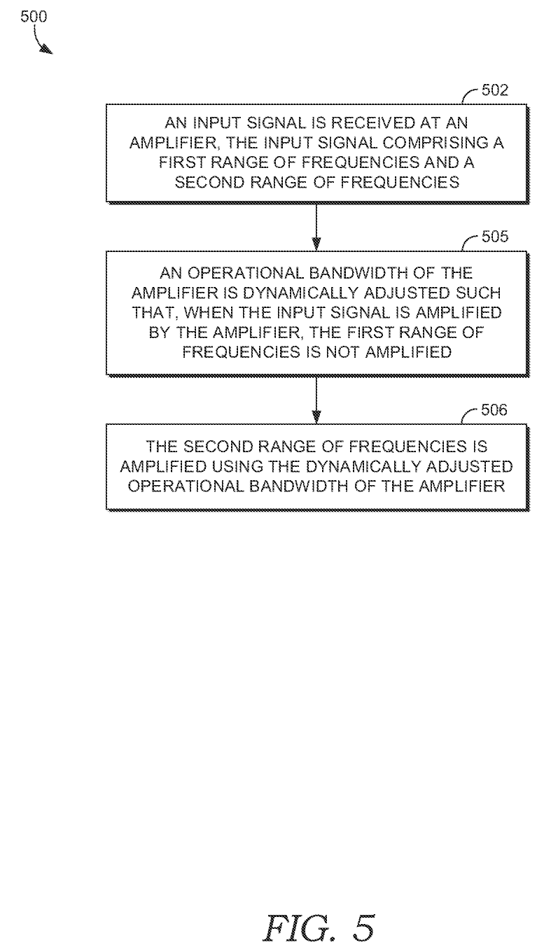

Turning now to FIG. 5, a flow chart is provided that illustrates one or more aspects of the present disclosure relating to a method 500 for mitigating energy transmitted on subcarriers in a communications network. For example, at a first step 502, an input signal is received at an amplifier, the input signal comprising a first range of frequencies and a second range of frequencies. At a second step 504, an operational bandwidth of the amplifier is dynamically adjusted such that, when the input signal is amplified by the amplifier, the first range of frequencies is not amplified. At a third step 506, the second range of frequencies is amplified using the dynamically adjusted operational bandwidth of the amplifier.

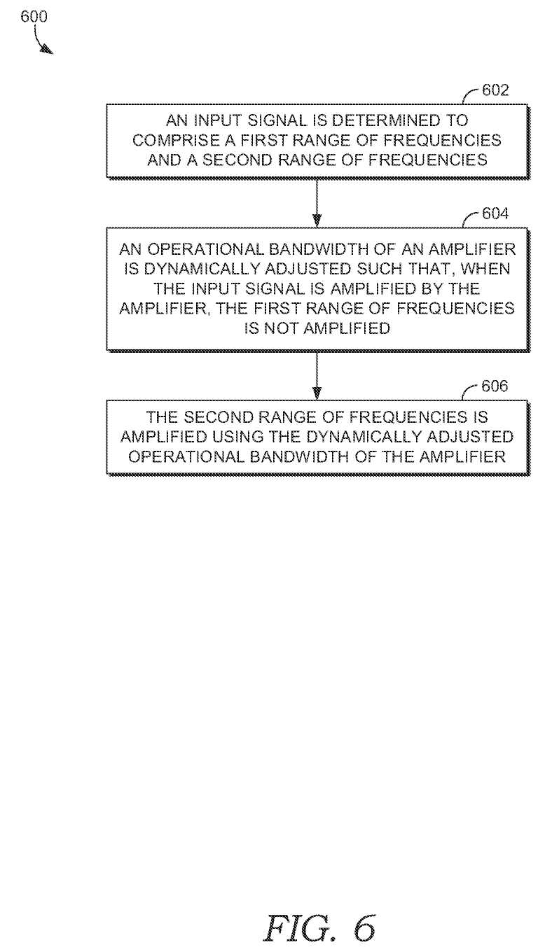

Turning now to FIG. 6, a flow chart is provided that illustrates one or more aspects of the present disclosure relating to a method 600 for mitigating energy transmitted on subcarriers in a communications network. For example, at a first step 602, an input signal is determined to comprise a first range of frequencies and a second range of frequencies. At a second step 604, an operational bandwidth of an amplifier is dynamically adjusted such that, when the input signal is amplified by the amplifier, the first range of frequencies is not amplified. At a third step 606, the second range of frequencies is amplified using the dynamically adjusted operational bandwidth of the amplifier.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for mitigating energy transmitted on subcarriers in a communications network, the system comprising:
a radio unit comprising an amplifier:
a network device comprising one or more processors: and a non-transitory computer-readable media comprising executable instructions that,
when executed, causes the network device to perform operations in the communications network, the executable instructions comprising the steps of:
receiving an input signal at the amplifier; the input signal comprising a first range of frequencies and a second range of frequencies: determining that the first range of frequencies comprises Physical Resource Blocks (PRBs)
dynamically adjusting an operational bandwidth of the amplifier such that, when the input signal is amplified by the amplifier, the first range of frequencies is not amplified: and amplifying the input signal using the dynamically adjusted operational bandwidth of the amplifier.

2. The system of claim 1, wherein the input signal is a baseband signal that has been converted to an analog signal.

3. The system of claim 1, wherein the second range of frequencies comprises only non-blanked PRBs.

4. The system of claim 1, wherein the input signal is received from a transceiver module of a base station.

5. The system of claim 1, wherein the input signal is received from a transceiver module of a user equipment.

6. The system of claim 1, the first range of frequencies is determined to comprise blanked PRBs based on scheduling data associated with the input signal received from a scheduler in the communications network.

7. The system of claim 6, wherein the scheduling data comprises digital signal data.

8. The system of claim 6, wherein the scheduling data associated with the input signal comprises a list of non-blanked PRBs and a list of blanked PRBs.

9. The system of claim 1, wherein dynamically adjusting the operational bandwidth of the amplifier comprises narrowing the operational bandwidth to exclude the first range of frequencies.

10. The system of claim 1, further comprising:
determining that the second range of frequencies comprises non-blanked PRBs; and
dynamically adjusting the operational bandwidth of the amplifier such that, when the input signal is amplified, the second range of frequencies is amplified.

11. The system of claim 10, wherein dynamically adjusting the operational bandwidth of the amplifier comprises broadening the operational bandwidth to include the second range of frequencies.

12. A non-transitory computer-readable media comprising executable instructions that, when executed, causes a network device comprising one or more processors to perform operations for mitigating energy transmitted on subcarriers in a communications network, the executable instructions comprising the steps of:
receiving an input signal at an amplifier, the input signal comprising a first range of frequencies and a second range of frequencies; dynamically adjusting an operational bandwidth of the amplifier such that, when the input signal is amplified by the amplifier, the first range of frequencies is not amplified; and amplifying the second range of frequencies using the dynamically adjusted operational bandwidth of the amplifier.

13. The computer-readable media of claim 12 further comprising determining that the first range of frequencies comprises blanked Physical Resource Blocks (PRBs).

14. The computer-readable media of claim 13, the first range of frequencies is determined to comprise blanked PRBs based on scheduling data associated with the input signal received from a scheduler in the communications network.

15. The computer-readable media of claim 12, wherein the second range of frequencies comprises only non-blanked Physical Resource Blocks (PRBs).

16. The computer-readable media of claim 12, wherein dynamically adjusting the operational bandwidth of the amplifier comprises narrowing the operational bandwidth to exclude the first range of frequencies.

17. A method for mitigating energy transmitted on subcarriers in a communications network, the method comprising:
determining that an input signal comprises a first range of frequencies and a second range of frequencies; dynamically adjusting an operational bandwidth of an amplifier such that, when the input signal is amplified, the first range of frequencies is not amplified; and amplifying the second range of frequencies using the dynamically adjusted operational bandwidth.

18. The method of claim 17, wherein the first range of frequencies is determined to comprise blanked PRBs.

19. The method of claim 17, wherein dynamically adjusting the operational bandwidth of the amplifier comprises narrowing the operational bandwidth to exclude the first range of frequencies.

20. The method of claim 17 further comprising receiving the input signal at the amplifier.
